(19) United States
(12) Patent Application Publication
(10) Pub. No.: US 2020/0130300 A1
(43) Pub. Date: Apr. 30, 2020

(54) COATING METHOD

(71) Applicant: Nidec Corporation, Kyoto (JP)

(72) Inventors: Akinori YAMAMOTO, Kyoto (JP); Takashi NAKAYAMA, Kyoto (JP); Keiichiro SHINOKI, Kyoto (JP); Muneyuki OTANI, Kyoto (JP); Takanori KAMOTO, Kyoto (JP)

(21) Appl. No.: 16/493,771

(22) PCT Filed: Feb. 26, 2018
(86) PCT No.: PCT/JP2018/006920

§ 371 Date: Sep. 13, 2019

(30) Foreign Application Priority Data
Mar. 15, 2017 (JP) 2017-049878

(51) Int. Cl. B29D 11/00; B05D 1/40; B05D 1/26; G02B 1/115; G02B 3/00

(52) U.S. Cl. CPC B29D 11/00865; B05D 1/40; G02B 3/00; G02B 1/115; B05D 1/26

(57) ABSTRACT

A coating method includes a) supplying a coating liquid including a resin to a lens surface of a lens body made of a resin, the lens surface being on one side of the lens body, and b) forming a film of the coating liquid on the lens surface by rotating the lens body around a predetermined rotational axis. The film of the coating liquid is a buffer layer provided between the lens body and an anti-reflection layer. When the lens surface is a convex surface, the viscosity of the coating liquid is about 8 mPa·s or more and about 26 mPa·s or less and a number of revolutions of the lens body in the step b) is about 4500 rpm or more and about 30000 rpm or less.

### CROSS REFERENCE TO RELATED APPLICATIONS

This is a U.S. national stage of PCT Application No. PCT/JP2018/006920, filed on Feb. 26, 2018, and priority under 35 U.S.C. § 119(a) and 35 U.S.C. § 365(b) is claimed from Japanese Application No. 2017-049878, filed Mar. 15, 2017; the entire disclosures of each application are hereby incorporated herein by reference.

### 1. FIELD OF THE INVENTION

The present disclosure relates to a coating method.

### 2. BACKGROUND

Conventionally, with an optical lens formed from glass, an anti-reflection layer is provided on a surface. In the formation of the anti-reflection layer, an inorganic substance is coated on a lens body by a vapor evaporation method or the like. Since both the lens body and the anti-reflection layer are formed from an inorganic substance, high tight adhesion is obtained between them. Also, since their physical properties, such as the coefficient of linear expansion, are close to each other, even if a temperature change or humidity change occurs, problems such as a crack and peel are less likely to occur.

Recently, to make a lens lightweight and to reduce its cost, it has been attempted to form a lens body from a resin. In Japanese Unexamined Patent Application Publication No. 2011-191395, for example, a lens body composed of an optical resin material is disclosed. An optical functional film formed from an anti-reflection film is formed on the surface of the lens body by vapor evaporation.

Incidentally, in Japanese Unexamined Patent Application Publication No. 2008-86923, a method is disclosed in which an anti-reflection film is formed on a lens body by a spin coat method. In the method, a coating liquid with a viscosity of 20 cP or less is used and the lens body is rotated at 8000 rpm or more. In Japanese Unexamined Patent Application Publication No. 2007-72248, a method is disclosed in which a coating is formed on a hybrid lens, which is formed by joining a resin layer to the base material of a glass lens, by a spin coat method. In the method, a coating liquid with a viscosity of 0.1 to 10 cP is used and the hybrid lens is rotated at 1200 rpm or more.

If an anti-reflection layer is provided directly on the surface of a lens body made of a resin, however, there is the problem that a crack or the like occurs in the anti-reflection layer in a high-temperature environment or the like due to a difference in the coefficient of linear expansion between the lens body and the anti-reflection layer. Therefore, it can be thought that a buffer layer, which is an intermediate layer, is provided between the lens body and the buffer layer to prevent a crack or the like.

In reality, however, if the buffer layer is too thin, it is not possible to prevent a crack or the like in the anti-reflection layer. Also, if the buffer layer is too thick, variations in the thickness of the buffer layer become large and the shape of the lens is essentially distorted. As for a lens including a buffer layer and an anti-reflection layer, therefore, to prevent a crack or the like in the anti-reflection layer and to assure predetermined lens performance, it is necessary to have the thickness of the buffer layer and variations in the thickness fall within their respective predetermined ranges. Accordingly, there is a demand for a method of easily forming a film, suitable for a buffer layer, that has a thickness and variations in the thickness that fall within their respective predetermined ranges.

### SUMMARY

Example embodiments of the present disclosure are able to easily form a film suitable for a buffer layer.

An example embodiment of a coating method of the present disclosure includes a) supplying a coating liquid including a resin to a lens surface of a lens body made of a resin, the lens surface being on one side of the lens body, and b) forming a film of the coating liquid on the lens surface by rotating the lens body around a predetermined rotational axis. The film of the coating liquid is a buffer layer provided between the lens body and an anti-reflection layer.

When the lens surface is a convex surface, the viscosity of the coating liquid is about 8 mPa·s or more and about 26 mPa·s or less and a number of revolutions of the lens body in the step b) is about 4500 rpm or more and about 30000 rpm or less.

When the lens surface is a concave surface, the viscosity of the coating liquid is about 4 mPa·s or more and about 26 mPa·s or less and the number of revolutions of the lens body in the step b) is about 8000 rpm or more and about 30000 rpm or less.

When the lens surface is not distinguished according to whether it is a convex surface or concave surface, the viscosity of the coating liquid is about 8 mPa·s or more and about 26 mPa·s or less and the number of revolutions of the lens body in the step b) is about 8000 rpm or more and about 30000 rpm or less.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a cross-sectional view indicating the structure of a lens according to an example embodiment of the present disclosure.

FIG. 2 is a drawing indicating a flow of lens manufacturing according to an example embodiment of the present disclosure.

FIG. 3 is a drawing to explain the formation of a buffer layer according to an example embodiment of the present disclosure.

FIG. 4 is a drawing to explain the formation of the buffer layer.

FIG. 5 is a drawing to explain the formation of the buffer layer.

FIG. 6 is a drawing indicating the thickness of the buffer layer and its PV value for a plurality of combinations of the viscosity of a coating liquid and the number of revolutions of a lens body.

FIG. 7 is a drawing indicating the thickness of the buffer layer and its PV value for a plurality of combinations of the viscosity of the coating liquid and the number of revolutions of the lens body.

FIG. 8 is a drawing explaining relationships among the viscosity of the coating liquid, the number of revolutions of the lens body, the thickness of the buffer layer, and its PV value.

FIG. 9 is a drawing indicating the thickness of the buffer layer and its PV value for a plurality of combinations of the viscosity of the coating liquid and the number of revolutions of the lens body.

FIG. 10 is a drawing explaining relationships among the viscosity of the coating liquid, the number of revolutions of the lens body, the thickness of the buffer layer, and its PV value.

### DETAILED DESCRIPTION

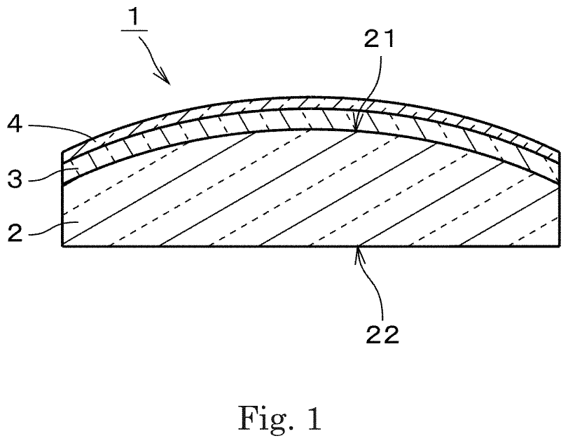

FIG. 1 is a cross-sectional view indicating the structure of a lens 1 according to one example embodiment of the present disclosure. The lens 1 is, for example, is a lens that is placed at the outermost portion, that is, the portion closest to an object side, of a lens unit provided in an imaging apparatus for a vehicle. The lens 1 may be a lens other than the outermost lens of a lens unit.

The lens 1 includes a lens body 2, a buffer layer 3, and an anti-reflection layer 4. The lens body 2 is made of a resin. For example, the lens body 2 is composed of only a resin. Various types of resins can be used to form the lens body 2. For example, an acrylic resin, an amorphous polyolefin resin, a polycarbonate resin, and the like can be used.

The thickness of the lens body 2 on the optical axis of the lens 1 is, for example, 0.3 mm (millimeter) or more, and is preferably 1.5 mm or more. In the example in FIG. 1, the thickness of the lens body 2 is 2.96 mm. In consideration of ordinary applications of lenses made of a resin, the thickness of the lens body 2 is, for example, 12 mm or less. The thickness of the lens body 2 is preferably 8.0 mm or less, and is more preferably 5.0 mm or less. The diameter of the lens body 2 is, for example, 3.0 mm or more, and is preferably 7.0 mm or more. Here, the diameter of the lens body 2 is the diameter of a region that functions as a lens. In the example in FIG. 1, the diameter of the lens body 2 is 11.6 mm. In consideration of ordinary applications of lenses made of a resin, the diameter of the lens body 2 is, for example, 30 mm or less. The diameter of the lens body 2 is preferably 20 mm or less, and is more preferably 15 mm or less.

The lens body 2 includes two lens surfaces 21 and 22. One lens surface 21 is a surface placed on the object side and is a convex surface. The lens surface 21 is, for example, a spherical surface. The curvature radius of the lens surface 21 is, for example, 8 mm or more, and is preferably 10 mm or more. In the example in FIG. 1, the curvature radius of the lens surface 21 is 13.8 mm. When the lens 1 is used as the outermost lens in the imaging apparatus described above, the curvature radius of the lens surface 21, which is a convex surface, is, for example, 10 mm or more, and is preferably 12 mm or more. The other lens surface 22 is a surface placed on an image side. In FIG. 1, the lens surface 22 is a flat surface. The lens surface 22 may be a convex surface or may be a concave surface.

The buffer layer 3 is disposed on the lens surface 21. Preferably, the buffer layer 3 is disposed directly on the lens surface 21. That is, the buffer layer 3 is in contact with the lens surface 21. The buffer layer 3 is, for example, a layer, made of a resin including inorganic particles, is a transparent thin film. In the buffer layer 3, inorganic particles are dispersed in the resin layer. By using a resin including an inorganic substance for the buffer layer 3, it is possible to achieve an abrasion-resistant film with high hardness. As the resin, an acrylic resin, an amorphous polyolefin resin, or the like, for example, can be used. The organic particles may include, for example, amorphous silica particles and particles of a metal oxide such as alumina. The organic particles may include particles of other than metal oxides. A preferable buffer layer 3 has higher hardness than the lens body 2. The buffer layer 3 of this type is also referred to as the hard coat layer.

The anti-reflection layer 4 is provided on the buffer layer 3. Preferably, the anti-reflection layer 4 is provided directly on the buffer layer 3. That is, the anti-reflection layer 4 is in contact with the buffer layer 3. The anti-reflection layer is, for example, is made of an inorganic oxide and is a transparent thin film. As the inorganic oxide, metal oxides, such as silicon dioxide, titanium oxide, lanthanum titanate, tantalum oxide and niobium oxide, and the like for example, can be used. In a preferable anti-reflection layer 4, a plurality of types of metal oxide layers are laminated.

Due the presence of the buffer layer 3 provided between the lens body 2 and the anti-reflection layer 4, the tight adhesion of the anti-reflection layer 4 is improved in the lens 1. Also, the coefficient of linear expansion of the buffer layer 3 is between the coefficient of linear expansion of the lens body 2 and the coefficient of linear expansion of the anti-reflection layer 4. Due to the buffer layer 3, stress is reduced that is generated in the anti-reflection layer 4 due to a difference in the coefficient of linear expansion between the lens body 2 and the anti-reflection layer 4. As a result, the generation of a crack attributable to a temperature change is prevented in the anti-reflection layer 4. In this specification, “crack” in the anti-reflection layer means damage, caused in the anti-reflection layer, such as a fine crack or a fine peel. A water repellent layer and other functional layers may be provided on the anti-reflection layer 4. Alternatively, functional layers may be provided on the other lens surface 22.

To more reliably prevent the generation of a crack in the anti-reflection layer 4, the thickness of the buffer layer 3 is, for example, 0.5 μm (micrometer) or more, is preferably 1.0 μm or more, and is more preferably 1.5 μm or more. If the thickness of the buffer layer 3 is excessively large, effects on various types of performance of the lens 1 become large, so the thickness of the buffer layer 3 is preferably 3.5 μm or less and is more preferably 3.0 μm or less. The thickness of the buffer layer 3 can be measured with, for example, an optical film thickness meter or the like.

Also, if variations in the thickness of the buffer layer 3 are large, various types of performance of the lens 1 are lowered. A PV value, for example, can be used as an index that indicates variations in the thickness of the buffer layer 3, that is, the evenness of the thickness of the buffer layer 3. The PV value indicates a difference between the maximum value and minimum value of the thickness of the buffer layer 3 at different positions of the lens surface 21. To assure various types of performance of the lens 1, the PV value is preferably 4.5 μm or less, and is more preferably 3.0 μm or less. In the calculation of the PV value of the buffer layer 3, the surface shape of the lens surface 21 is measured by using, for example, a contact-type surface shape measuring instrument before and after the buffer layer 3 is formed. Then, a difference in height at each position is obtained when these surface shapes are overlapped, and a difference between the maximum value and minimum value of differences at all positions is obtained as the PV value.

The thickness of the anti-reflection layer 4 is, for example, 0.05 μm or more and 0.90 μm or less, and is preferably 0.10 μm or more and 0.60 μm or less. The thickness of the anti-reflection layer 4 is smaller than the thickness of the buffer layer 3. The thickness of the anti-reflection layer 4 can be measured with, for example, an optical film thickness meter or the like as with the buffer layer 3.

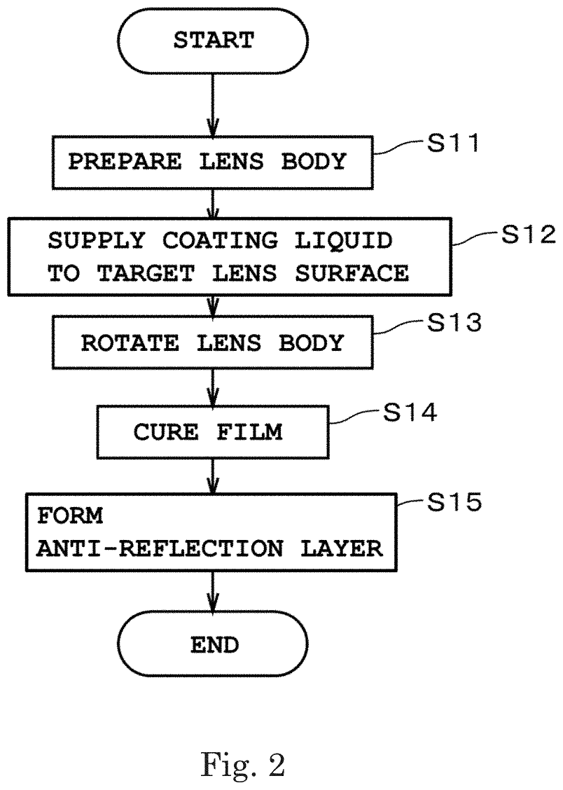

Next, the manufacturing of the lens 1 will be described with reference to FIG. 2. In the manufacturing of the lens 1, the lens body 2 is prepared first (step S11). The lens body 2 is formed by, for example, injection molding a lens body forming material. The lens body forming material includes a resin or the like that has been exemplified as the material of the lens body 2. The resin is thermoplastic. After the lens body 2 made of a resin has been prepared, the buffer layer 3 is formed on the one lens surface 21 of the lens body 2.

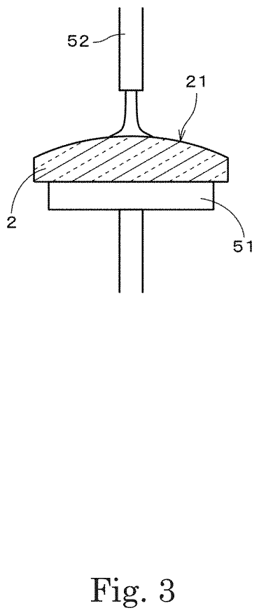

FIG. 3 to FIG. 5 are drawings used to explain the formation of the buffer layer 3. In the formation of the buffer layer 3, the lens body 2 is first placed on a rotational retaining portion 51 in a coating apparatus indicated in FIG. 3. The lens body 2 is retained on the rotational retaining portion 51 by a clamp mechanism, which is omitted in the drawing. The lens body 2 may be retained by suction, adsorption, or the like. The rotational retaining portion 51 is rotatable around a shaft by a motor, which is omitted in the drawing. In this processing example, in state in which the lens surface 21, which is a convex surface, faces upward, the lens body 2 is retained in a stationary state by the rotational retaining portion 51. In the description below, the lens surface 21 will be referred to as “target lens surface 21”.

Next, a coating liquid is dropped from a nozzle 52 placed above the rotational retaining portion 51 onto the target lens surface 21 by a predetermined amount, so the coating liquid is supplied to the target lens surface 21 (step S12). Preferably, the coating liquid is dropped onto the center of the target lens surface 21. The coating liquid is in a liquid form including inorganic particles and a resin. The coating liquid, which includes the inorganic particles, resin, and the like that have been exemplified as the material of the buffer layer 3, is a buffer layer forming material. For example, the coating liquid also includes a volatile organic solvent or the like. In this processing example, the coating liquid has an ultraviolet curing property. The coating liquid may have a thermosetting property depending on the material or the like of the lens body 2. When the buffer layer 3 is formed on the target lens surface 21, which is a convex surface, the viscosity of the coating liquid is, for example, 8 mPa·s (millipascal-seconds) or more and 26 mPa·s or less. It is preferable for the viscosity of the coating liquid to be 14 mPa·s or more. An example of the coating liquid is a liquid in which a solvent including amorphous silica, an acrylic resin, a photo polymerization starting agent, and PGM (propylene glycol monomethyl ether) as the main components is mixed at a desired ratio.

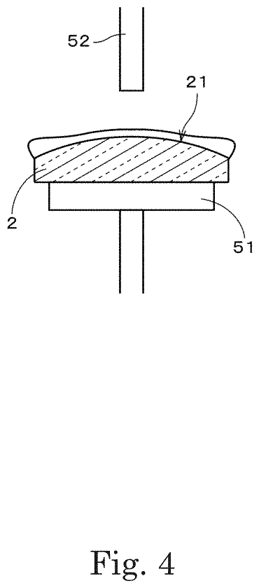

In the coating apparatus, the stationary state of the lens body 2 is maintained until a predetermined time elapses after the coating liquid is dropped. Since the wettability of the coating liquid to the target lens surface 21 is high, the coating liquid on the target lens surface 21 spreads and reaches the outer edge of the target lens surface 21 while the stationary state of the lens body 2 is maintained. Preferably, the coating liquid reaches the outer edge of the target lens surface 21 over its entire circumference. That is, the coating liquid reaches the whole of the outer edge of the target lens surface 21. According to this, the whole of the target lens surface 21 is covered by the coating liquid. A time taken from when the coating liquid is dropped onto the target lens surface 21 until the coating liquid covers the whole of the target lens surface 21 is, for example, 3 seconds or less and is preferably 2.5 seconds or less. The time is, for example, 0.1 second or more. Typically, the coating liquid is retained by its surface tension on the outer edge of the target lens surface 21, as indicated in FIG. 4. In other words, it is preferable that an amount by which the coating liquid is dropped onto the target lens surface 21 be adjusted to an amount up to which the coating liquid is retained on the target lens surface 21 in the stationary state. As described above, in the supply of the coating liquid to the target lens surface 21, the coating liquid is dropped onto the target lens surface 21 and the stationary state of the lens body 2 is maintained.

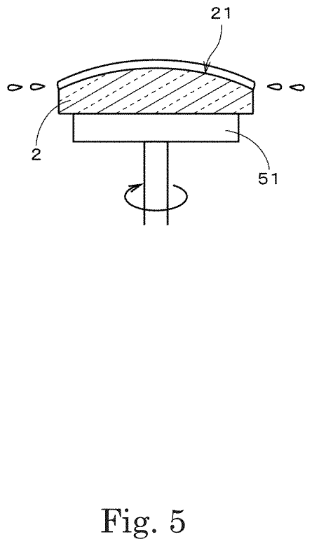

Next, the rotational retaining portion 51 rotates the lens body 2 at a predetermined number of revolutions as indicated in FIG. 5 (step S13). Here, the center line of the shaft, that is, the rotational axis, matches an optical axis, which is the center line of the lens body 2. Therefore, the lens body 2 rotates around the center line. The rotational speed of the lens body 2 is raised from the stationary state to a set number of revolutions in a short time and is maintained at the number of revolutions. The number of revolutions of the lens body 2 in this processing example, is, for example, 4500 rpm or more and 30000 rpm or less. It is preferable for the number of revolutions of the lens body 2 to be 20000 rpm or less. Due to the rotation of the lens body 2, an excess of the coating liquid flies out of the outer edge of the target lens surface 21, so the excess of the coating liquid is removed. Thus, a film of the coating liquid is formed. After a predetermined time elapses from the start of the rotation of the lens body 2, the rotation of the lens body 2 is stopped.

The lens body 2 is removed from the rotational retaining portion 51 and is transported to a light irradiation apparatus. The light irradiation apparatus includes a light source portion that emits ultraviolet light. The lens body 2 is placed at a position illuminated by the ultraviolet light. By emitting a predetermined amount of ultraviolet light to the film of the coating liquid on the target lens surface 21, the film is cured (step S14). The emission of ultraviolet light may be carried out in a state in which the lens body 2 is retained on the rotational retaining portion 51. By curing the film, on the target lens surface 21, of the coating liquid is cured as described above, the buffer layer 3, which is a covering layer, is formed. The buffer layer 3 is a film of the cured coating liquid.

After the buffer layer 3 is formed, the anti-reflection layer 4 is formed on the buffer layer 3 (step S15). In the formation of the anti-reflection layer 4, a film of an anti-reflection forming material is formed on the buffer layer 3 by, for example, a vapor evaporation method. A preferable vapor evaporation method is an ion-assisted method. A film having a high tight adhesion property and a high denseness property is formed by an ion assisted method. The anti-reflection layer 4 may be formed by a sputtering method or the like. The anti-reflection forming material includes an inorganic oxide and the like that have been exemplified as the material of the anti-reflection layer 4. An example of the anti-reflection layer 4 is a multi-layer film in which a thin film of silicon dioxide and a thin-film of titanium oxide are alternately laminated. The multi-layer film is, for example, a set of five or seven thin films. Due to the processing described above, the lens 1 is manufactured.

As described above, in the application of the coating liquid to the lens body 2, the coating liquid is dropped onto the target lens surface 21 and the stationary state is maintained until the coating liquid reaches the outer edge of the target lens surface 21. After that, by rotating the lens body 2 around the predetermined rotational axis, an excess of the coating liquid is removed from the target lens surface 21. Thus, a film of the coating liquid can be appropriately formed on the target lens surface 21 without excessively using the coating liquid.

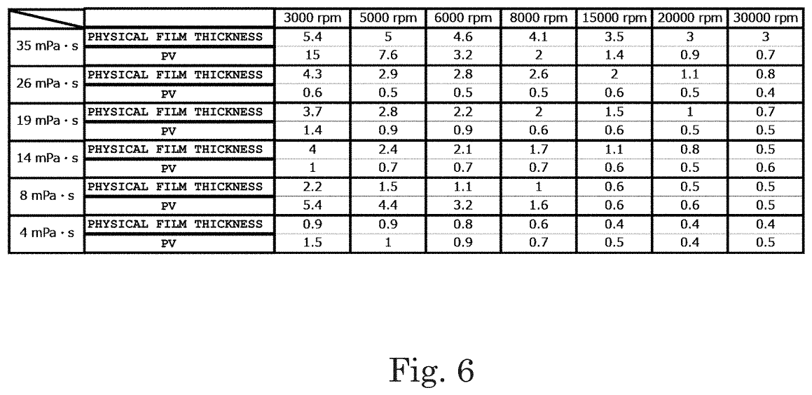

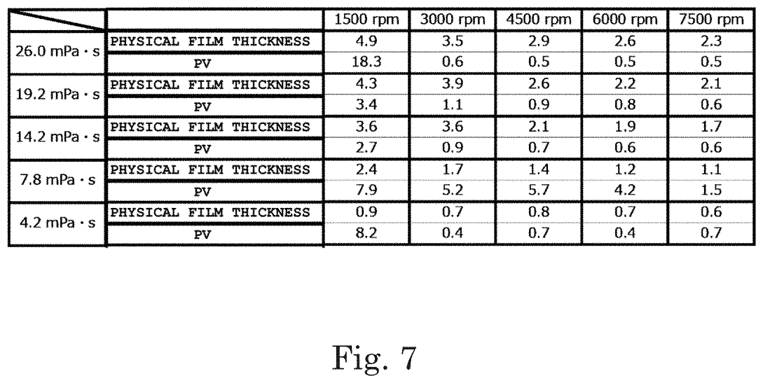

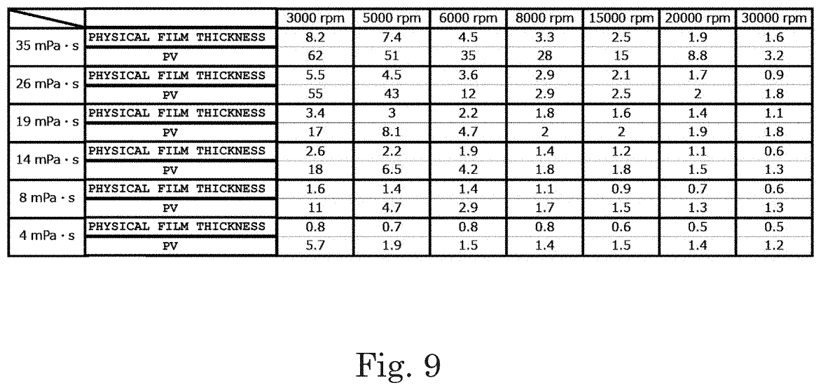

Next, a preferable viscosity of the coating liquid and a preferable number of revolutions of the lens body 2 in a case in which the buffer layer 3 is formed on the target lens surface 21, which is a convex surface, will be described. FIG. 6 and FIG. 7 are each a drawing indicating the thickness of the buffer layer 3 and its PV value for a plurality of combinations of the viscosity of a coating liquid and the number of revolutions of the lens body 2. In FIG. 6 and FIG. 7, the thickness of the buffer layer 3 is indicated in “physical film thickness” rows, and PV values are indicated in “PV” rows. The unit of the thickness of the buffer layer 3 and the unit of PV values are both micrometers (μm). Similarly, this holds for FIG. 9 described later.

In the experience in FIG. 6, the lens body 2 with a diameter of 8.5 mm and a curvature radius of 30 mm was used. In the experience in FIG. 7, the lens body 2 with a diameter of 11.5 mm and a curvature radius of 23 mm was used. The thickness of the buffer layer 3 was measured at the center position of the lens body 2 with an optical film thickness meter. In the measurement of PV values, a contact-type surface shape measuring instrument was used. Specifically, before the formation of the buffer layer 3, the surface shape of the target lens surface 21 was measured, and after the formation of the buffer layer 3, the surface shape of the buffer layer 3 was measured. Then, a difference in height at each position was obtained when these surface shapes were overlapped. Next, a difference between the maximum value and minimum values of differences at all positions was obtained as the PV value.

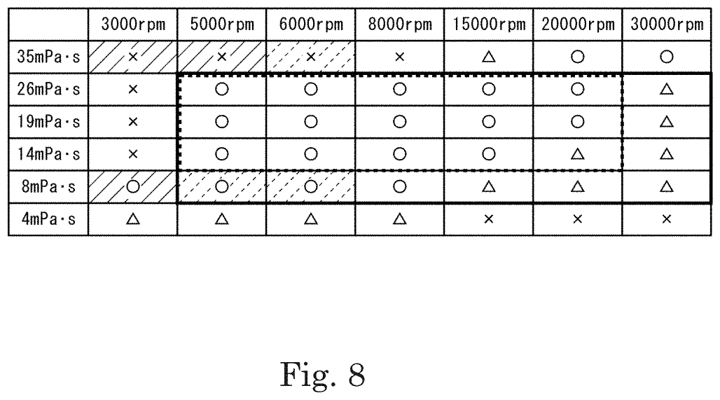

FIG. 8 is a drawing explaining relationships among the viscosity of the coating liquid, the number of revolutions of the lens body 2, the thickness of the buffer layer 3, and its PV value. In FIG. 8, “x” is indicated in a cell indicating a combination in which the thickness of the buffer layer 3 is less than 0.5 μm and a cell indicating a combination in which the thickness of the buffer layer 3 is more than 3.5 μm, the combination being one of a plurality of combinations, in FIG. 6, of the viscosity of the coating liquid and the number of revolutions of the lens body 2. Also, “Δ” is indicated in a cell indicating a combination in which the thickness of the buffer layer 3 is 0.5 μm or more and less than 1.0 μm and a cell indicating a combination in which the thickness of the buffer layer 3 is more than 3.0 μm and 3.5 μm or less, and “O” is indicated in a cell indicating a combination in which the thickness of the buffer layer 3 is 1.0 μm or more and 3.0 μm or less. In addition, in FIG. 8, a cell indicating a combination in which the PV value is more than 4.5 μm is hatched with solid lines, the combination being one of a plurality of combinations of the viscosity of the coating liquid and the number of revolutions of the lens body 2, and a cell indicating a combination in which the PV value is more than 3.0 μm and 4.5 μm or less is hatched with broken lines. A cell indicating a combination in which the PV value is 3.0 μm or less is not hatched.

When the viscosity of the coating liquid is 8 mPa·s or more and 26 mPa·s or less and the number of revolutions of the lens body 2 is 5000 rpm or more and 30000 rpm or less, buffer layers 3 that have a thickness of 0.5 μm or more and 3.5 μm or less and also have a PV value of 4.5 μm or less are obtained, as indicated by the bold solid-line rectangle in FIG. 8. In reality, it is found from the results in FIG. 7 that when the viscosity of the coating liquid is 8 mPa·s or more, even if the number of revolutions of the lens body 2 is 4500 rpm, buffer layers 3 that have a thickness and a PV value included in the above range are obtained. Therefore, the lower limit of the number of revolutions of the lens body 2 in the bold solid-line range is 4500 rpm. Similarly, this holds for the lower limit of the number of revolutions of the lens body 2 in a bold dashed-line range described later.

When, in the above bold solid-line range, the viscosity of the coating liquid is restricted to 14 mPa·s or more and the number of revolutions of the lens body 2 is restricted to 20000 rpm or less as enclosed by the bold broken-line rectangle in FIG. 8, buffer layers 3 that have a PV value of 3.0 μm or less, actually, less than 1.0 μm are obtained. In most of this range, the thickness of the buffer layer 3 is 1.0 μm or more and 3.0 μm or less. If the thickness of the buffer layer 3 is restricted to 1.5 μm or more to reliably prevent the occurrence of a crack in the anti-reflection layer 4, the number of revolutions of the lens body 2 is restricted to 8000 rpm or less in the above bold broken-line range. Alternatively, it is preferable that, in the above bold broken-line range, the viscosity of the coating liquid be restricted to 19 mPa·s or more and the number of revolutions of the lens body 2 be restricted to 15000 rpm or less.

As described above, when the target lens surface 21 is a convex surface, it is preferable that the viscosity of the coating liquid be 8 mPa·s or more and 26 mPa·s or less, and the number of revolutions of the lens body 2 be 4500 rpm or more and 30000 rpm or less. Thus, a film that has a thickness and variations in thickness that fall within their predetermined ranges and is suitable to the buffer layer 3 can be easily formed. Also, when the viscosity of the coating liquid is 14 mPa·s or more and the number of revolutions of the lens body 2 is 20000 rpm or less, a film suitable for the buffer layer 3 can be more reliably formed. The curvature radius of the target lens surface 21, which is a convex surface, is, for example, 8 mm or more and 30 mm or less.

Next, a preferable viscosity of the coating liquid and a preferable number of revolutions of the lens body 2 in a case in which the buffer layer 3 is formed on the target lens surface 21 that is a concave surface will be described. FIG. 9 is a drawing indicating the thickness of the buffer layer 3 and its PV value for a plurality of combinations of the viscosity of the coating liquid and the number of revolutions of the lens body 2. In the experience in FIG. 9, the lens body 2 with a diameter of 6 mm and a curvature radius of 3 mm was used.

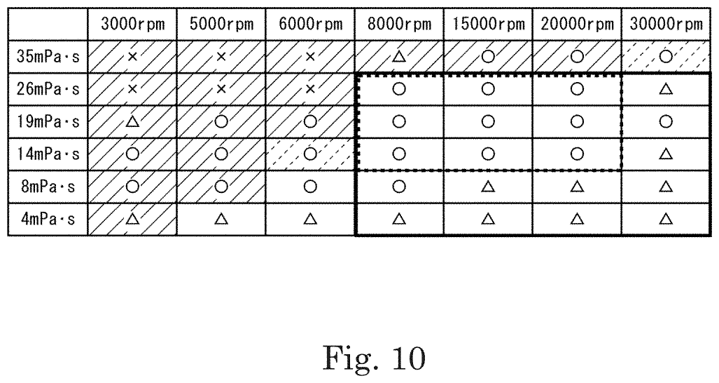

FIG. 10 is a drawing explaining relationships among the viscosity of the coating liquid, the number of revolutions of the lens body 2, the thickness of the buffer layer 3, and its PV value. In FIG. 10, “x”, “Δ”, and “O”, indicated in cells indicating combinations of the viscosity of the coating liquid and the number of revolutions of the lens body 2, are based on the same references as in FIG. 8. The references for hatching with solid lines, hatching with broken lines, and non-hatching indicated in cells indicating combinations are also the same as in FIG. 8.

When the viscosity of the coating liquid is 4 mPa·s or more and 26 mPa·s or less and the number of revolutions of the lens body 2 is 8000 rpm or more and 30000 rpm or less, buffer layers 3 that have a thickness of 0.5 μm or more and 3.5 μm or less and also have a PV value of 3.0 μm or less are obtained, as indicated by the bold solid-line rectangle in FIG. 10. Also, when, in the above bold solid-line range, the viscosity of the coating liquid is restricted to 14 mPa·s or more and the number of revolutions of the lens body 2 is restricted to 20000 rpm or less as enclosed by the bold broken-line rectangle in FIG. 10, buffer layers 3 that have a thickness of 1.0 μm or more and 3.0 μm or less are obtained. When the thickness of the buffer layer 3 is restricted to 1.5 μm or more to more reliably prevent the generation of a crack in the anti-reflection layer 4, it is preferable that, in the above bold dashed-line range, the viscosity of the coating liquid be restricted to 19 mPa·s or more and the number of revolutions of the lens body 2 be restricted to 15000 rpm or less.

As described above, when the target lens surface 21 is a concave surface, it is preferable that the viscosity of the coating liquid be 4 mPa·s or more and 26 mPa·s or less, and the number of revolutions of the lens body 2 be 8000 rpm or more and 30000 rpm or less. Thus, a film that has a thickness and variations in thickness that fall within their predetermined ranges and is suitable to the buffer layer 3 can be easily formed. Also, when the viscosity of the coating liquid is 14 mPa·s or more and the number of revolutions of the lens body 2 is 20000 rpm or less, a film suitable for the buffer layer 3 can be more reliably formed. The curvature radius of the target lens surface 21, which is a concave surface, is, for example, 1 mm or more and 5 mm or less.

When the results in FIG. 8 and FIG. 10 are generalized regardless whether the target lens surface 21 is a convex surface or concave surface, that is, the target lens surface 21 is not distinguished according to whether it is a convex surface or concave surface, a range in which the bold solid-line rectangle in FIG. 8 and the bold dashed-line rectangle in FIG. 10 overlap is preferable. That is, it is preferable that the viscosity of the coating liquid be 8 mPa·s or more and 26 mPa·s or less, and the number of revolutions of the lens body 2 be 8000 rpm or more and 30000 rpm or less. Due to this, a film suitable for the buffer layer 3 can be easily formed. Also, when the viscosity of the coating liquid is 14 mPa·s or more and the number of revolutions of the lens body 2 is 20000 rpm or less, a film suitable for the buffer layer 3 can be more reliably formed. Furthermore, when the viscosity of the coating liquid is 19 mPa·s or more and the number of revolutions of the lens body 2 is 15000 rpm or less, it is possible to more reliably prevent the generation of a crack in the anti-reflection layer 4 by restricting the thickness of the buffer layer 3 to 1.5 μm or more.

As for the lens 1 and the coating method for the lens 1, which have been described above, various variations are possible.

The position onto which the coating liquid is dropped in step S12 in FIG. 2 may be other than the center of the target lens surface 21. In this case, the stationary state of the lens body 2 is maintained until the coating liquid reaches at least part of the outer edge of the target lens surface 21. Preferably, the stationary state of the lens body 2 is maintained until the coating liquid reaches the whole of the outer edge of the target lens surface 21. Also, lyophilic processing to enhance wettability to the coating liquid may be performed for the target lens surface 21 before the coating liquid is supplied to the target lens surface 21. Lyophilic processing is, for example, discharge processing or the like.

The rotational axis around which the lens body 2 rotates may deviate from the center line of the lens body 2. Also, the coating liquid may be dropped onto the target lens surface 21 while the lens body 2 is being rotated. The supply of the coating liquid to the target lens surface 21 may be performed by immersing, that is, dipping, the target lens surface 21 into the coating liquid stored in a vessel. In this case as well, it is possible to easily form a film suitable for the buffer layer 3 by having the viscosity of the coating liquid and the number of revolutions of the lens body 2 fall within the above ranges.

The lens 1 may be used in other than an imaging apparatus for a vehicle.

The structures in the above example embodiment and variations may be appropriately combined within a range in which any contradiction does not occur among these structures.

The present disclosure can be used in the application of a coating liquid to lenses in various applications.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-9 (canceled)

10. A coating method comprising:
a) supplying a coating liquid including a resin to a lens surface of a lens body made of a resin, the lens surface being on one side of the lens body; and
b) forming a film of the coating liquid on the lens surface by rotating the lens body around a predetermined rotational axis; wherein
the film of the coating liquid is a buffer layer provided between the lens body and an anti-reflection layer;
a viscosity of the coating liquid is about 8 mPa·s or more and about 26 mPa·s or less; and
a number of revolutions of the lens body in the step b) is about 8000 rpm or more and about 30000 rpm or less.

11. The coating method according to claim 10, wherein
the viscosity of the coating liquid is about 14 mPa·s or more; and
the number of revolutions of the lens body in the step b) is about 20000 rpm or less.

12. The coating method according to claim 10, wherein
in the step a) the coating liquid is dropped onto the lens surface of the lens body retained in a stationary state, and the stationary state is maintained until the coating liquid reaches an outer edge of the lens surface; and
in the step b) an excess of the coating liquid is removed by a rotation of the lens body.

13. A coating method comprising:
a) supplying a coating liquid including a resin to a lens surface of a lens body made of a resin, the lens surface being on one side of the lens body; and
b) forming a film of the coating liquid on the lens surface by rotating the lens body around a predetermined rotational axis; wherein
the lens surface is a convex surface;
the film of the coating liquid is a buffer layer provided between the lens body and an anti-reflection layer;
a viscosity of the coating liquid is about 8 mPa·s or more and about 26 mPa·s or less; and
a number of revolutions of the lens body in the step b) is about 4500 rpm or more and about 30000 rpm or less.

14. The coating method according to claim 13, wherein
the viscosity of the coating liquid is about 14 mPa·s or more; and
the number of revolutions of the lens body in the step b) is about 20000 rpm or less.

15. The coating method according to claim 13, wherein
in the step a) the coating liquid is dropped onto the lens surface of the lens body retained in a stationary state, and the stationary state is maintained until the coating liquid reaches an outer edge of the lens surface; and
in the step b) an excess of the coating liquid is removed by a rotation of the lens body.

16. A coating method comprising:
a) supplying a coating liquid including a resin to a lens surface of a lens body made of a resin, the lens surface being on one side of the lens body; and
b) forming a film of the coating liquid on the lens surface by rotating the lens body around a predetermined rotational axis; wherein
the lens surface is a concave surface;
the film of the coating liquid is a buffer layer provided between the lens body and an anti-reflection layer;
a viscosity of the coating liquid is about 4 mPa·s or more and about 26 mPa·s or less; and
a number of revolutions of the lens body in the step b) is about 8000 rpm or more and about 30000 rpm or less.

17. The coating method according to claim 16, wherein
the viscosity of the coating liquid is about 14 mPa·s or more; and
the number of revolutions of the lens body in the step b) is about 20000 rpm or less.

18. The coating method according to claim 16, wherein:
in the step a) the coating liquid is dropped onto the lens surface of the lens body retained in a stationary state, and the stationary state is maintained until the coating liquid reaches an outer edge of the lens surface; and
in the step b) an excess of the coating liquid is removed by a rotation of the lens body.
